(19) United States
(12) Patent Application Publication
(10) Pub. No.: US 2009/0107565 A1
(43) Pub. Date: Apr. 30, 2009

(54) Fuel Tank

(75) Inventors: Donald S. Hanson, Evans, GA (US); Jim Consiglio, Evans, GA (US); Nicholas Herdegen, Franklin, MI (US); Barbara Sammons, Grovetown, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/926,981

(22) Filed: Oct. 29, 2007

(51) Int. Cl. B60K 15/03; B29C 49/00; B65D 25/00

(52) U.S. Cl. 137/544; 137/565.01; 264/564

(57) ABSTRACT

A fuel tank is provided including an integrally formed body. The body includes a generally hollow portion defined by an outer wall and a fill neck extending around an aperture in the outer wall. The body further includes a mounting tab generally extending from the body and a snap-fit retainer configured to engage an accessory mounted to the fuel tank.

### FIELD

The present teachings relates to golf cars and more specifically to fuel tanks for golf cars.

### BACKGROUND

The statements in this section merely provide background information related to the present disclosure and may not constitute prior art.

Golf cars provide transportation for golfers around a golf course. A golf car must also securely carry a golf bag in a location for convenient access throughout a round of golf. Many gas-powered golf cars are equipped with fuel tanks coupled to a frame of the golf car. These fuel tanks include fuel pumps, fuel filters and fuel lines, as well as additional components coupled to the fuel tank. These fuel tanks are often coupled to the frame and/or other additional structures using tab members coupled to the tank. Often these tab members are formed independently of the body of the fuel tank. Additionally, these fuel tanks often include a fill neck at a gas filling location. These fill necks are also often formed independently of the body of the fuel tank. This can result in a more complicated design requiring greater cost and assembly times.

### SUMMARY

According to the present disclosure, a fuel tank is provided including an integrally formed body. The body includes a generally hollow portion defined by an outer wall and a fill neck extending around an aperture in the outer wall. A mounting tab extends from the body and a snap-fit retainer is configured to engage an accessory mounted to the fuel tank.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a perspective view of a golf car including the fuel tank assembly of the present teachings;

FIG. 2 is a perspective view showing the fuel tank assembly of the present teachings coupled to the golf car frame;

FIG. 3 is an exploded view showing the fuel tank assembly of FIG. 2;

FIG. 4 is a perspective view of the fuel tank of FIG. 2; and

FIG. 5 is a bottom perspective view of the fuel tank of FIG. 2.

### DETAILED DESCRIPTION OF THE VARIOUS EMBODIMENTS

The following description of various embodiments is merely exemplary in nature and is in no way intended to limit the present teachings, application, or uses.

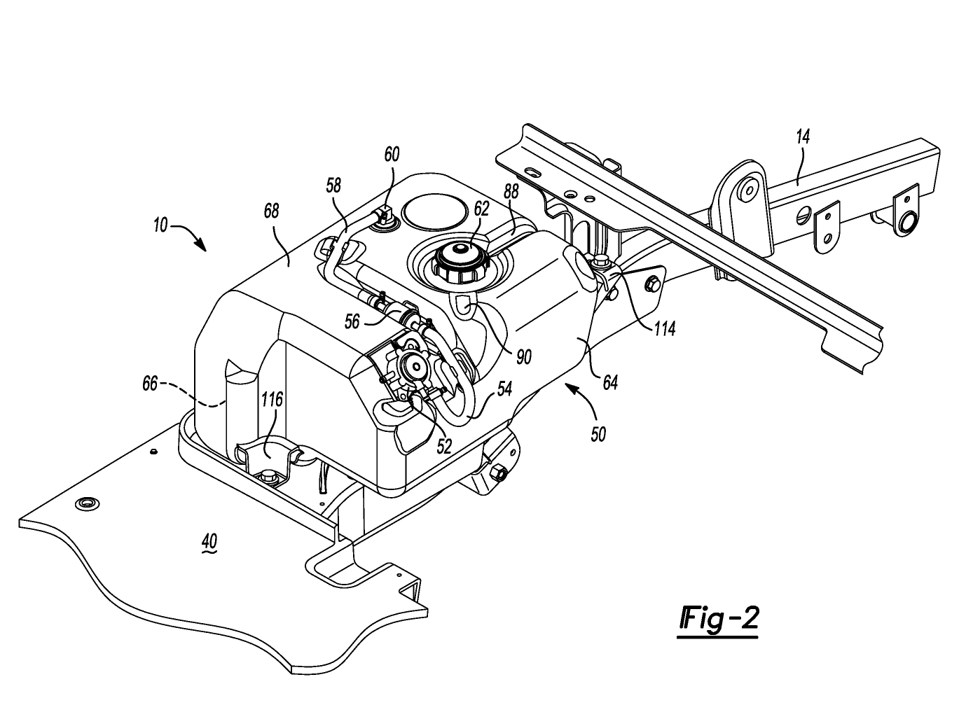

With initial reference to FIG. 2, a fuel tank assembly constructed in accordance to the present disclosure is shown and identified generally at reference numeral 10. The fuel tank assembly 10 is illustrated operably connected to an exemplary golf car 12. It is appreciated that the golf car 12 is merely exemplary and that the fuel tank assembly 10 can be adapted for use with other golf car configurations. Furthermore, the fuel tank assembly 10 described herein is not limited for use with golf cars and can also be used with other vehicles such as, but not limited to, utility vehicles, lawnmowers, and other turf care vehicles.

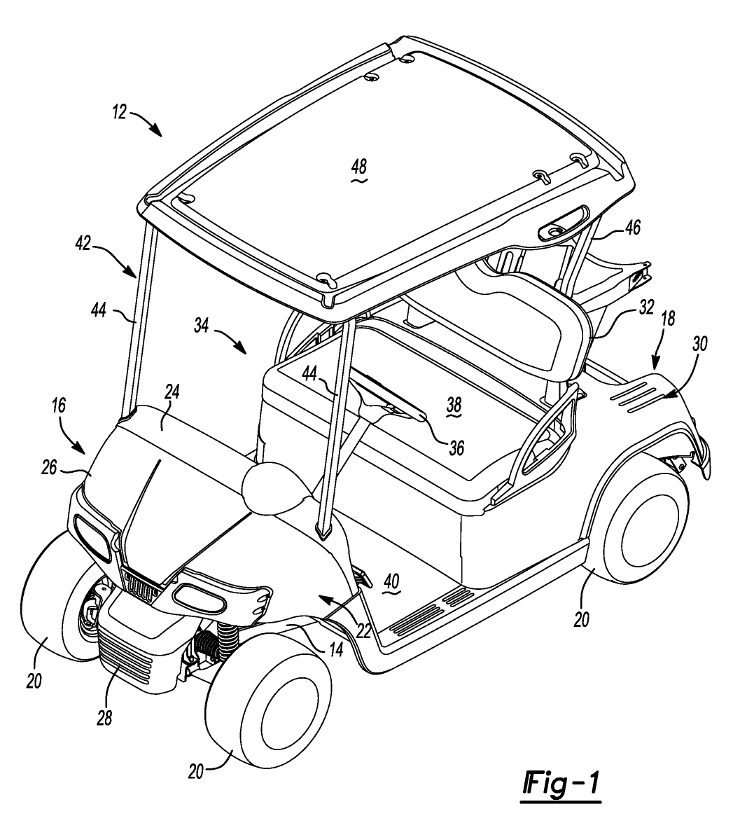

As shown in FIG. 1, the golf car 12 can include a frame 14 having a front portion 16 and a rear portion 18 mounted thereon. The golf car 12 can further include wheels 20 drivingly coupled to the frame 14.

The front portion 16 of golf car 12 can include a front body assembly 22 having an instrument panel 24, a front cowl 26, and a bumper 28. The rear portion 18 can include a rear body assembly 30 having a golf bag storage area 32 and a passenger seating area 34. The passenger seating area 34 can include a steering wheel 36, accelerator and brake pedals (not shown), a seat 38, and a floor portion 40.

The golf car 12 can further include a strut assembly 42. The strut assembly 42 can include a pair of front struts 44 and a pair of rear struts 46 supporting a roof canopy 48. The pair of front struts 44 can extend between the front portion 16 of the golf car 12 and the roof canopy 48 and the pair of rear struts 46 can extend between the rear portion 18 of the golf car 12 and the roof canopy 48.

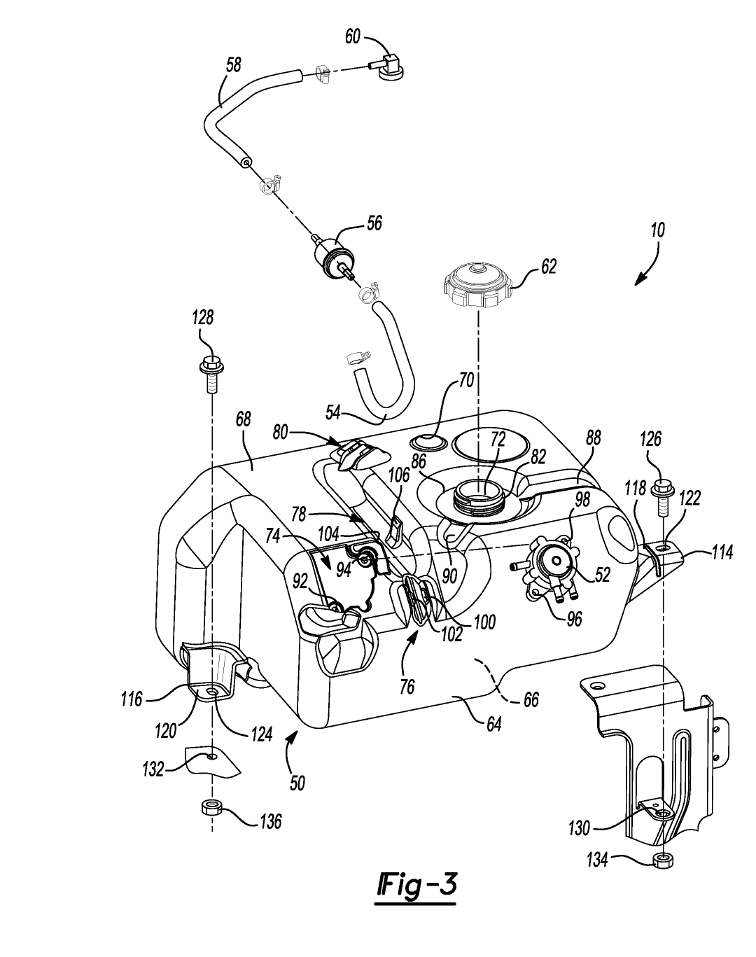

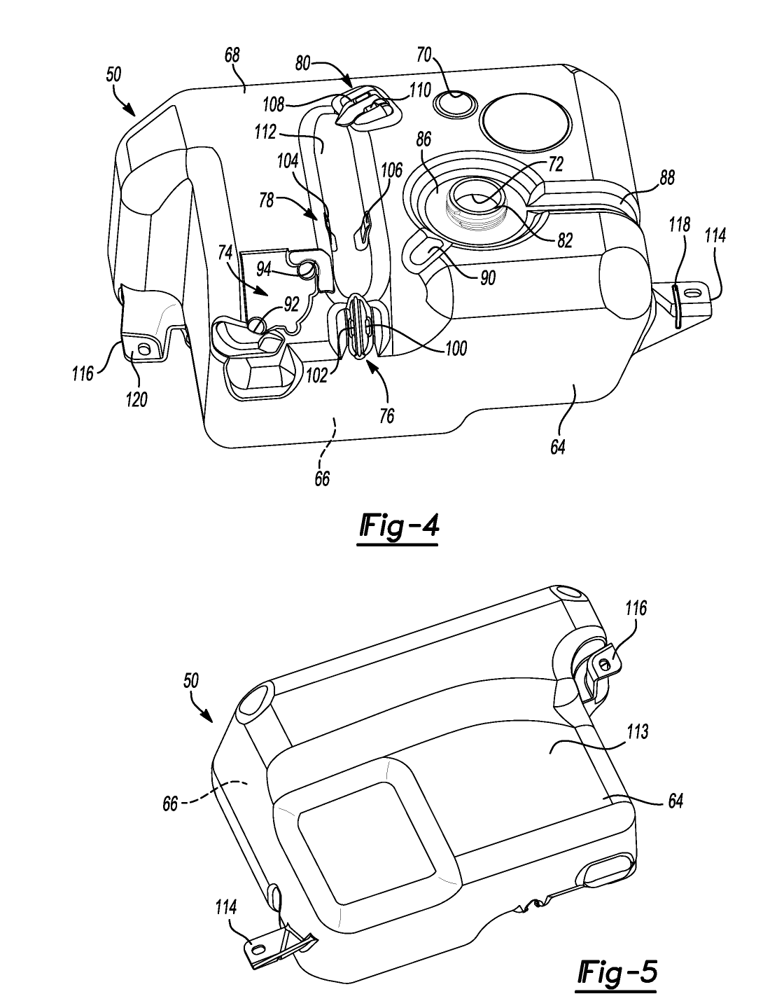

As seen in FIGS. 2-5, golf car 12 can include a fuel tank assembly 10. The fuel tank assembly 10 can include a fuel tank 50, a fuel pump 52, a first fuel line 54, a fuel filter 56, a second fuel line 58, a fuel line connector 60, and a fuel cap 62. The fuel tank 50 can include an integrally formed body 64 having a generally hollow portion 66 defined by an outer wall 68. Outer wall 68 can include a first aperture 70, a second aperture 72, and snap-fit retainers 74, 76, 78, 80.

First aperture 70 can be coupled to and in communication with fuel line connector 60. Fuel line connector 60 can be coupled to and in communication with the second fuel line 58. Second aperture 72 can be used as a filling location for adding fuel to fuel tank 50. A fill neck 82 can generally extend around second aperture 72. Fill neck 82 can be a generally cylindrical member. The outer surface of fill neck 82 can be threaded or otherwise adapted for engagement with the cap 62. Fill neck 82 can be formed generally simultaneously with the other portions of fuel tank 50 through a process such as blow molding.

Fill neck 82 can be surrounded by a recessed portion 86 of outer wall 68. The recessed portion 86 can generally surround fill neck 82 and have drains paths 88, 90 extending therefrom. Drains paths 88, 90 can generally guide overflow fuel away from the body 64 of fuel tank 50.

Snap-fit retainers 74, 76, 78, 80 can generally eliminate the need for fasteners, such as screws, for coupling components (fuel pump 52, fuel lines 54, 58, and fuel filter 56) to fuel tank 50. The first snap-fit retainer 74 can include snap-fit portions 92, 94 and can couple a fuel pump 52 to fuel tank 50 without the need for fasteners. Snap-fit portions 92, 94 can generally be in the form of protrusions and can generally extend from outer wall 68 and engage flange portions 96, 98 of fuel pump 52 in a partially overlapping and interference fit.

The second snap-fit retainer 76 can couple the first fuel line 54 to fuel tank 50. The second snap-fit retainer 76 can include snap-fit portions 100, 102 and generally engage first fuel line 54 therebetween. The snap-fit portions 100, 102 are configured to receive first fuel line 54 in an interference fit.

The third snap-fit retainer 78 can couple the fuel filter 56 to fuel tank 50. The third snap-fit retainer 78 can include snap-fit portions 104, 106 and generally engage fuel filter 56 therebetween with an interference fit.

The fourth snap-fit retainer 80 can couple the second fuel line 58 to fuel tank 50. The fourth snap-fit retainer 80 can include snap-fit portions 108, 110 and generally engage second fuel line 58 therebetween with an interference fit.

A first recessed portion 112 is recessed sufficiently that it can be formed in the outer wall 68 on an upper portion of fuel tank 50. First recessed portion 112 is recessed sufficiently that it can generally house the first and second fuel lines 54, 58 and fuel filter 56. A second recessed portion 113 can be formed in the outer wall 68 on a lower portion of fuel tank 50. Second recessed portion 113 can generally allow passage of cables (not shown) therethrough.

The fuel tank 50 can also include mounting tabs 114, 116 generally extending from outer wall 68. The mounting tabs 114, 116 can include generally flat surfaces 118, 120 having apertures 122, 124 respectively therethrough. Fasteners 126, 128 can pass through apertures 122, 124 and corresponding apertures 130, 132 in frame 14 and can be engaged with nuts 134, 136, thereby coupling fuel tank 50 to frame 14. Floor portion 40 can be disposed between mounting tab 116 and frame 14 (seen in FIG. 2), resulting in fuel tank 50 being mounted to frame 14 and floor portion 40. Mounting tabs 114, 116 can be integrally formed generally simultaneously with the other portions of fuel tank 50 through a process such as blow molding.

As noted throughout the disclosure, the entire fuel tank 50 can be formed simultaneously as a unitary member through a process such as blow molding.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A fuel tank comprising:
an integrally formed body including a generally hollow portion defined by an outer wall, a fill neck extending around an aperture in said outer wall, a mounting tab generally extending from said body, and a snap-fit retainer configured to engage an accessory mounted to said fuel tank.

2. The fuel tank of claim 1, wherein said body includes a channel configured to allow passage of cables therethrough.

3. The fuel tank of claim 1, wherein said snap-fit retainer is configured to couple a fuel pump to said fuel tank.

4. The fuel tank of claim 1, wherein said snap-fit retainer is configured to couple a fuel line to said fuel tank.

5. The fuel tank of claim 1, wherein said snap-fit retainer is configured to couple a fuel filter to said fuel tank.

6. The fuel tank of claim 1, wherein said body includes a drain path adjacent said fill neck, said drain path configured to guide fuel overflow.

7. The fuel tank of claim 1, wherein said tab includes an aperture therethrough, said aperture configured for coupling said tab to a structure.

8. A method of making the fuel tank of claim 1, including simultaneously forming all parts of the fuel tank.

9. The method of claim 8, wherein said simultaneously forming includes blow molding the entire fuel tank.

10. A fuel tank assembly comprising:
a fuel pump;
a fuel filter in communication with said fuel pump;
a fuel line connecting said fuel pump to said fuel filter; and
a fuel tank having an integrally formed body including a generally hollow portion defined by an outer wall, a fill neck extending around an aperture in said outer wall, a mounting tab generally extending from said body, and a first snap-fit retainer engaged with said fuel pump.

11. The fuel tank assembly of claim 10, wherein said fuel tank includes an integrally formed second snap-fit retainer engaged with said fuel filter.

12. The fuel tank assembly of claim 10, wherein said fuel tank includes an integrally formed second snap-fit retainer engaged with said fuel line.

13. The fuel tank of claim 10, wherein said fuel tank body includes a drain path adjacent said fill neck, said drain path configured to guide fuel overflow.

14. A method of making the fuel tank of claim 10, including simultaneously forming all parts of the fuel tank.

15. The method of claim 16, wherein said simultaneously forming includes blow molding the entire fuel tank.

16. A vehicle comprising:
a frame; and
a fuel tank assembly including a fuel tank having an integrally formed body with a generally hollow portion defined by an outer wall, a fill neck extending around an aperture in said outer wall, a mounting tab generally extending from said body and coupled to said frame, and a first snap-fit retainer configured to engage an accessory mounted to said fuel tank.

17. The vehicle of claim 16, further comprising a floor member, said gas tank mounted to both said frame and said floor member.

18. The vehicle of claim 16, wherein said fuel tank assembly further includes a fuel pump coupled to said fuel tank, a fuel filter in communication with said fuel pump, and a fuel line connecting said fuel pump to said fuel tank.

19. The vehicle of claim 18, wherein said fuel tank includes an integrally formed second snap-fit retainer engaged with said fuel pump.

20. The vehicle of claim 18, wherein said fuel tank includes an integrally formed second snap-fit retainer engaged with said fuel filter.

21. The vehicle of claim 18, wherein said fuel tank includes an integrally formed second snap-fit retainer engaged with said fuel line.

22. The vehicle of claim 16, wherein said vehicle is a golf car.
